(19) United States
(12) Patent Application Publication
(10) Pub. No.: US 2002/0081980 A1
(43) Pub. Date: Jun. 27, 2002

(54) Sound reproduction apparatus for use in vehicular audio applications

(76) Inventor: Richard J. Reus, Villa Park, CA (US)

Correspondence Address: The Law of Offices of K.W. Float, Box 80790, Rancho Santa Margarita, CA, 92688-0790, US

(21) Appl. No.: 09/749,066

(22) Filed: Dec. 27, 2000

(51) Int. Cl. H04R 1/02

(52) U.S. Cl. 455/90; 381/86; 381/389

(57) ABSTRACT

Apparatus for use with an audio system in a vehicle. The apparatus comprises an enclosure with a reflective front surface and one or more speakers disposed within, protruding from, or disposed on a rear surface thereof that are coupled to the audio system. The speakers are sized and tailored to image and reflect sound off of the windshield to occupants of the vehicle to provide for reproduction of the audio output from the audio system. Tailoring the frequency response of the speakers to the reflective characteristics of the windshield and to the acoustic characteristics of the of the passenger compartment of the vehicle permits optimization of the mid and high frequency sound output of the audio system. Audio signals may be coupled to the speakers by wires or FM transmission.

### BACKGROUND

The present invention relates generally to audio equipment, and more particularly, to sound reproduction apparatus for use with an audio system employed in a vehicle.

Conventional audio systems used in passenger vehicles, such as those installed by vehicle manufacturers, typically have an AM-FM radio and amplifier, and may include a cassette player and/or compact disk player. The amplifier is typically connected to front and rear sets of speakers. The sound reproduction quality from these types of audio systems is generally mediocre at best.

To improve the sound quality of such audio systems, aftermarket amplifiers and/or speakers have been installed in the vehicle that have improved performance. The amplifiers are typically multi-channel amplifier (including a crossover network) with subwoofer, bass, mid and high range speaker outputs. Additional sets of speakers are added to the system that are connected to the outputs the multi-channel amplifier.

In addition, rear view mirror devices have been developed that incorporate a radio receiver in the mirror housing. Such a device is discloses in U.S. Pat. No. 3,950,701 issued Apr. 13, 1976, entitled “Rear view mirror for a two-wheeled vehicle”. This device includes a hollow housing, a mirror mounted on a front surface of the housing that faces a driver of the vehicle, a loudspeaker and radio receiver mounted in the housing behind the mirror. A plurality of slots are formed on the front surface of the housing at the periphery of the mirror that pass the sound from the loudspeaker to outside the housing. Nothing is disclosed in this patent regarding a speaker mounted in an enclosure containing a rear view mirror that images sound off of the windshield of the vehicle.

U.S. Pat. No. 5,148,490 issued Sep. 15, 1992, entitled “Speaker with tweeter assembly mounted to the interior of the windshield of a vehicle” discloses a stereo speaker system having a tweeter that is movably and rotatably mounted on the interior of a vehicle's windshield so that the direction of the sound emanating from the tweeter can be adjusted to the preference of a listener. The tweeter is mounted in a shell that permits the tweeter to remain fixed in the shell or alternatively permits the tweeter to be rotated within the shell. The shell is mounted on the windshield of the vehicle. The shell may be mounted in a fixed orientation if the tweeter is rotatable within the shell. Alternatively, the shell may be mounted on a post with a rotatable bearing, comparable to the mounting of the rear view mirror in present day vehicles, so that the shell itself can be rotatable to orient the sound emanating from the tweeter in any desired direction. The tweeter may be rotatable within the shell to provide further refined directional orientation of the sound. Nothing is disclosed in this patent regarding a speaker mounted in an enclosure containing a rear view mirror that images sound off of the windshield of the vehicle.

U.S. Pat. No. 5,566,224 issued Oct. 15, 1996, entitled “Radio frequency communication device including a mirrored surface” discloses an RF communication device (telephone) that employs a mirrored surface. A speaker may be disposed on the bottom of a housing to permit hands-free operation of the telephone. However, nothing is disclosed in this patent regarding a speaker mounted in an enclosure containing a rear view mirror that is employed with an audio system of the vehicle or that images sound off of the windshield of the vehicle.

Accordingly, it would be advantageous to have sound reproduction apparatus for use with an audio system employed in a vehicle that improves the sound quality of an audio system employed in the vehicle.

### SUMMARY OF THE INVENTION

The present invention provides for novel apparatus that is used in conjunction with an audio system disposed in a vehicle. The apparatus includes an enclosure comprising a reflective front surface and one or more speakers disposed within the enclosure adjacent a rear surface thereof that are coupled to the audio system in the vehicle. Alternatively, selected ones of the speakers may protrude from the rear surface of the enclosure, or may be secured to the rear exterior surface of the enclosure. The one or more speakers image and reflect sound onto the windshield of the vehicle to provide for reproduction of the audio output from the audio system.

In one embodiment of the apparatus, the one or more speakers (such as high and/or mid range) are electrically connected to outputs of the audio system, typically its high range speaker outputs. In one embodiment of the apparatus, the one or more speakers are coupled to the audio system by way of a transmitter and receiver arrangement which couples audio signals to the speakers.

The sound output of the one or more speakers is transmitted through openings in the rear surface of the enclosure that are preferably covered by one or more speaker grilles. The openings permit substantially unobstructed sound output from the one or more speakers and protect the speakers.

The one or more speakers are sized and tailored to image sound output onto the windshield of the vehicle. The sound generated by the one or more speakers is reflected off of the windshield to occupants of the vehicle. Tailoring the frequency response of the one or more speakers to the reflective characteristics of the windshield and to the acoustic characteristics of the of the passenger compartment of the vehicle permits optimization of the mid and high frequency sound output from the audio system.

### BRIEF DESCRIPTION OF THE DRAWINGS

The various features and advantages of the present invention may be more readily understood with reference to the following detailed description taken in conjunction with the accompanying drawings wherein like reference numerals designate like structural elements, and in which:

FIG. 1 is a perspective view of one embodiment of apparatus in accordance with the principles of the present invention;

FIG. 2 illustrates the apparatus shown in FIG. 1 in a typical vehicular application;

FIG. 3 is a perspective view of another embodiment of apparatus in accordance with the principles of the present invention; and

FIG. 4 illustrates the apparatus shown in FIG. 3 in a vehicular application.

### DETAILED DESCRIPTION

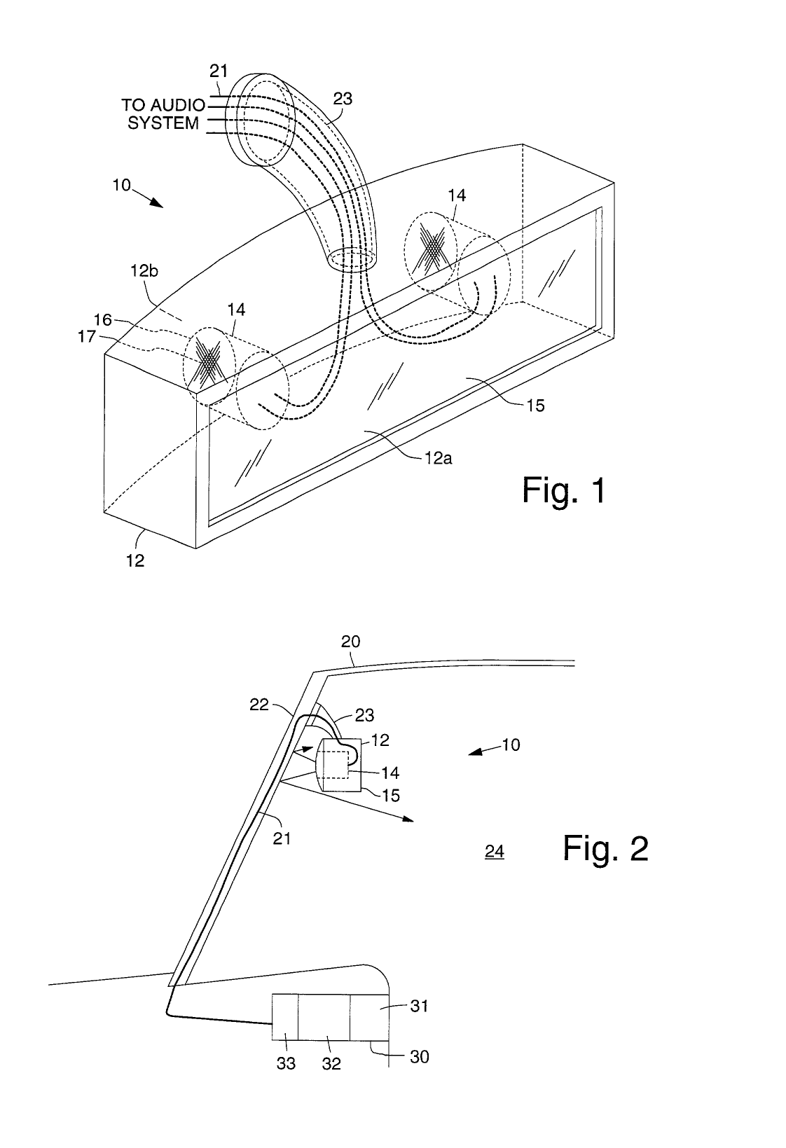

Referring to the drawing figures, FIG. 1 is a perspective view of a first embodiment of apparatus 10 in accordance with the principles of the present invention wherein internal components are shown in phantom. FIG. 2 illustrates the apparatus 10 disposed in a vehicle 20.

The apparatus 10 is used in conjunction with an audio system 30 in the vehicle 20. The apparatus 10 comprises an enclosure 12 comprising an optically reflective front surface 12a that is reflective towards a passenger compartment 24 (FIG. 2) of the vehicle 20. One or more speakers 14 are disposed within the enclosure 12 adjacent to a rear surface 12b thereof. The number of speakers 14 is typically two, but may be as few as one or as many as four or five, depending upon the application. The enclosure 12 is attached to the windshield 22 of the vehicle 20 by way of a support 23. The one or more speakers 14 are coupled to the audio system 20 in the vehicle 20 by way of electrical wires 21 such as conventional speaker wires 21.

The one or more speakers 14 image and reflect sound onto the windshield 22 of the vehicle 20 to provide for reproduction of the audio output from the audio system 30. The one or more speakers 14 are preferably tweeter speakers 14 that reproduce relatively high frequency audio signals, typically between about 10 KHz and about 20 KHz, for example. However, it is to be understood that mid range and/or tweeter speakers 14 may be employed that reproduce audio signals between about 150 Hz and about 20 KHz, for example.

The reflective front surface 12a of the enclosure faces away from the windshield 22 toward occupants, and in particular toward the driver, of the vehicle 20. The reflective front surface 12a preferably comprises a generally flat optically reflective rear view mirror 15 for viewing to the rear of the vehicle 20. The one or more, and preferably two, speakers 14 are disposed within the enclosure 12 adjacent the rear surface 12b of the enclosure 12. One or more openings 16 are provided in the rear surface 12b of the enclosure 12 and are preferably covered by one or more speaker grilles 17. The one or more openings 16 allow substantially unrestricted sound output from the one or more speakers 14 and protect the speakers 14.

The one or more speakers 14 are typically attached to the inside of the rear surface 12b of the enclosure 12 by adhesive, for example. However, the one or more speakers 14 may be secured within the enclosure 12 in any conventional manner, such as by screws and nuts, for example. Furthermore, it is to be understood that selected ones of the one or more speakers 14 may protrude or extend from the rear surface of the enclosure 12, or may be secured to the rear exterior surface of the enclosure 12. The one or more speakers 14 are electrically connected to outputs of the audio system 30. For example, the audio system 30 may include an AM-FM radio 31, a multichannel amplifier 32 (including a crossover network 33) having subwoofer, bass, and mid and high range speaker outputs may be provided whose high range speaker outputs are connected to the one or more speakers 14 of the apparatus 10.

The one or more speakers 14 are specifically sized and tailored to image sound output onto the windshield 22 of the vehicle 20. The sound generated by the one or more speakers 14 is reflected off of the windshield 22 to occupants of the vehicle 20. Tailoring the frequency response of the one or more speakers 14 to the reflective characteristics of the windshield 22 and to the acoustic characteristics of the of the passenger compartment 24 of the vehicle 20 permits optimization of the high frequency sound output from the audio system 30.

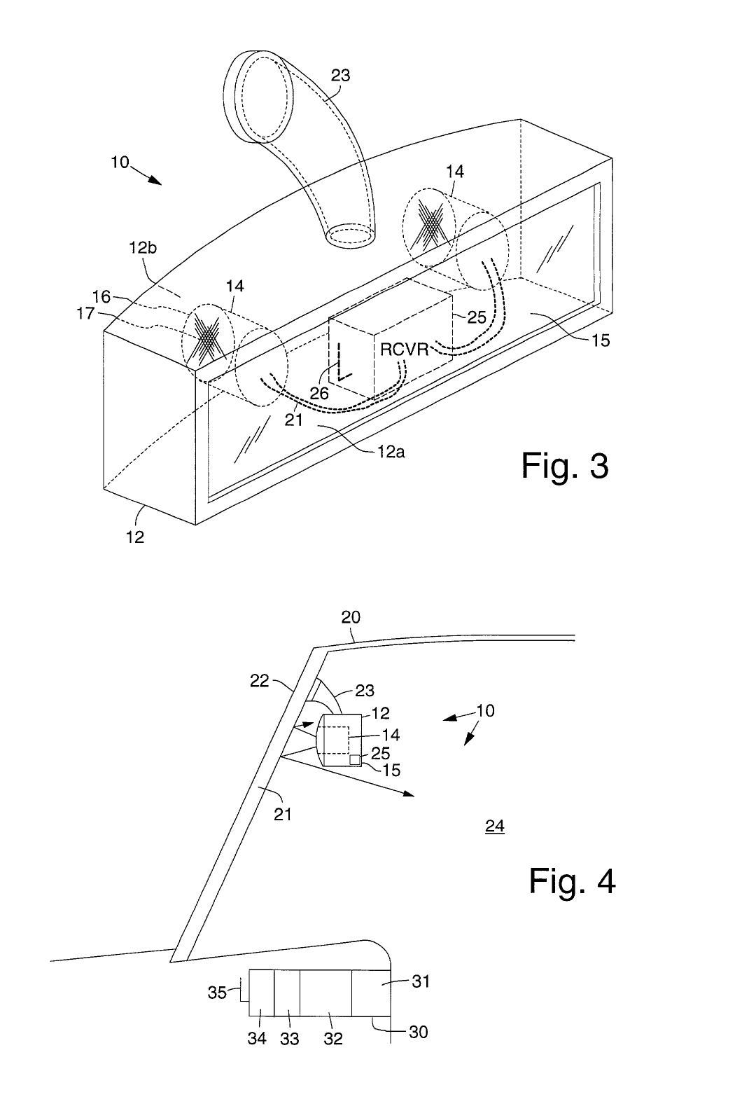

FIG. 3 is a perspective view of a second embodiment of the apparatus 10 in accordance with the principles of the present invention. FIG. 4 illustrates the apparatus 10 shown in FIG. 3 in a typical vehicular application.

The apparatus shown in FIGS. 3 and 4 is constructed substantially as described with reference to FIGS. 1 and 2, but the speakers 14 are not coupled to the audio system 30 by wires 21. Instead, the selected outputs of the audio system 30 are coupled to a transmitter 34 and an antenna 35, such as an FM transmitter 34 and antenna 35, which transmits the audio signals intended for the speakers 14 as FM signals. The FM signals are received by a receiver 25 by way of an antenna 26 that is preferably disposed within the enclosure 12. This, of course, eliminates unnecessary wiring in the vehicle 20. The FM transmitter 34 may be a separate circuit in enclosure 12 or may be an integrated circuit chip built into a circuit board coupled to the one or more speakers.

Although the above-described embodiment has been described with reference to speakers 14 disposed in the enclosure 12 that are preferably tweeter speakers 14, it is to be understood that one or more midrange and/or full range speakers 14 may also be disposed within or protrude from the enclosure 12. Such midrange and/or full range speakers 14 may be coupled to the audio system 30 by wires 21 or the RF transmission arrangement comprising the transmitter 34 and receiver 25 .

Thus, audio apparatus for use with an audio system employed in a vehicle that improves the sound quality of a vehicle audio system has been disclosed. It is to be understood that the above-described embodiment is merely illustrative of some of the many specific embodiments that represent applications of the principles of the present invention. Clearly, numerous and other arrangements can be readily devised by those skilled in the art without departing from the scope of the invention.

What is claimed is:

1. Apparatus for use in a vehicle, comprising:
an enclosure having an optically reflective front surface that generally faces to the rear of the vehicle; and
one or more speakers disposed adjacent a rear surface of the enclosure that image and reflect sound onto a windshield of the vehicle.

2. The apparatus recited in claim 1 wherein selected ones of the one or more speakers are disposed within the enclosure.

3. The apparatus recited in claim 2 wherein selected ones of the one or more speakers protrude from a rear surface of the enclosure.

4. The apparatus recited in claim 1 wherein selected ones of the one or more speakers are secured to a rear exterior surface of the enclosure.

5. The apparatus recited in claim 1 wherein the one or more speakers comprise tweeter speakers.

6. The apparatus recited in claim 1 wherein the one or more speakers comprise mid-range speakers.

7. The apparatus recited in claim 1 wherein the one or more speakers reproduce audio signals between about 150 Hz and about 20 KHz.

8. The apparatus recited in claim 1 wherein the one or more speakers are attached to an inside surface of the rear surface of the enclosure by adhesive.

9. The apparatus recited in claim 1 further comprising:
a transmitter coupled to the audio system for transmitting selected audio signals; and
a receiver coupled to the one or more speakers for coupling the selected audio signals transmitted by the transmitter to the one or more speakers.

10. Apparatus for use with an audio system disposed in a vehicle, comprising:
an enclosure having an optically reflective front surface; and
one or more speakers disposed adjacent a rear surface of the enclosure that are coupled to the audio system that image and reflect sound produced by the audio system onto a windshield of the vehicle to provide for reproduction of the audio output from the audio system.

11. The apparatus recited in claim 10 wherein the audio system comprises an AM-FM radio, a multi-channel amplifier, a crossover network, and high range speaker outputs that are connected to the one or more speakers by way of electrical connections.

12. The apparatus recited in claim 10 wherein selected ones of the one or more speakers are disposed within the enclosure.

13. The apparatus recited in claim 12 wherein selected ones of the one or more speakers protrude from a rear surface of the enclosure.

14. The apparatus recited in claim 10 wherein selected ones of the one or more speakers are secured to a rear exterior surface of the enclosure.

15. The apparatus recited in claim 10 wherein the one or more speakers comprise tweeter speakers.

16. The apparatus recited in claim 10 wherein the one or more speakers comprise mid-range speakers.

17. The apparatus recited in claim 10 wherein the one or more speakers reproduce audio signals between about 150 Hz and about 20 KHz.

18. The apparatus recited in claim 10 wherein the optically reflective front surface comprises a rear view mirror of the vehicle.

19. The apparatus recited in claim 10 further comprising:
a transmitter coupled to the audio system for transmitting selected audio signals; and
a receiver coupled to the one or more speakers for coupling the selected audio signals transmitted by the transmitter to the one or more speakers.
